(19) United States
(12) Patent Application Publication
(10) Pub. No.: US 2025/0214492 A1
(43) Pub. Date: Jul. 3, 2025

(54) SPINE LOAD REDUCTION SYSTEM FOR A VEHICLE SEAT

(71) Applicant: Volvo Car Corporation, Göteborg (SE)

(72) Inventors: Andreas Carlsson, Göteborg (SE); Peter Setterberg, Göteborg (SE); Peter Adolfsson, Göteborg (SE); Johan Rosenberg, Göteborg (SE); Katarina Bohman, Göteborg (SE); Magnus Björklund, Göteborg (SE); Fredrik Heurlin, Göteborg (SE); Jonas Östh, Göteborg (SE)

(21) Appl. No.: 18/396,910

(22) Filed: Dec. 27, 2023

(51) Int. Cl. B60N 2/427; B60N 2/42

(52) U.S. Cl. CPC B60N 2/42718; B60N 2/4221; B60N 2/42736; B60N 2/4279

(57) ABSTRACT

A system for reducing spine load during a collision. The system includes a seat assembly for a vehicle. The seat assembly includes a seat having a seat bottom, and further includes a linkage structure for coupling the seat bottom to a floor structure. The linkage structure enables movement of the seat bottom during a collision of the vehicle.

### INTRODUCTION

The present disclosure relates generally to the automotive and seating fields. A problem arises during vehicle collisions when occupants in a vehicle are positioned in highly reclined relaxed/resting positions. Highly reclined occupant positions and seat back angles increase the potential of dangerously large compressive lumbar spine loads in frontal crash scenarios. A highly reclined seating position results in the axis of the lumbar spine of the occupant to be more in line with the inertial load during an impact. Too high axial compressive lumbar spine force creates a risk of lumbar spine fractures, potentially with long-term consequences in the form of disability for the casualty.

The present introduction is provided as background context only and is not intended to be limiting in any manner. It will be readily apparent to those of ordinary skill in the art that the concepts and principles of the present disclosure may be implemented in other applications and contexts equally.

### SUMMARY

The present disclosure relates to a system for reducing the spine load of an occupant during a collision of a vehicle. In one illustrative embodiment, the present disclosure provides a seat assembly for a vehicle. The seat assembly includes a seat having a seat bottom; and a linkage structure for coupling the seat bottom to a floor structure. The linkage structure enables movement of the seat bottom during a collision of the vehicle. Optionally, in some embodiments, the linkage structure enables rotation of the seat bottom to rotate an occupant seated in the seat, to improve seat belt contact of the occupant, and to prevent submarining of the occupant during the collision. In some embodiments, the linkage structure enables forward movement of the seat bottom in a longitudinal direction to absorb forces experienced by an occupant seated in the seat during the collision. In some embodiments, the linkage structure enables downward movement of a rear portion of the seat bottom in the vertical direction to absorb forces experienced by an occupant seated in the seat during the collision. In some embodiments, the linkage structure enables a front portion of the seat bottom to lower and enables a rear portion of the seat bottom to rise during the collision. In some embodiments, the linkage structure is passive and moves the seat during the collision. In some embodiments, the linkage structure is active and moves the seat in anticipation of the collision. In some embodiments, at least a subset of the linkage structure is adapted to compress or extend in order to pivot the seat during the collision. In some embodiments, at least a subset of the linkage structure is adapted to deform during the collision.

In another illustrative embodiment, the present disclosure provides a vehicle including a seat having a seat bottom; and a linkage structure for coupling the seat bottom to a floor structure. The linkage structure enables movement of the seat bottom during a collision of the vehicle. Optionally, in some embodiments, the linkage structure enables rotation of the seat bottom to rotate an occupant seated in the seat, to improve seat belt contact of the occupant, and to prevent submarining of the occupant during the collision. In some embodiments, the linkage structure enables forward movement of the seat bottom in a longitudinal direction to absorb forces experienced by an occupant seated in the seat during the collision. In some embodiments, the linkage structure enables downward movement of a rear portion of the seat bottom in the vertical direction to absorb forces experienced by an occupant seated in the seat during the collision. In some embodiments, the linkage structure enables a front portion of the seat bottom to lower and enables a rear portion of the seat bottom to rise during the collision. In some embodiments, the linkage structure is passive and moves the seat during the collision. In some embodiments, the linkage structure is active and moves the seat in anticipation of the collision.

In a further illustrative embodiment, the present disclosure provides a method for manufacturing a seat assembly for a vehicle. The method includes adapting a linkage structure to couple a seat bottom of a seat to a floor structure. The method further includes adapting the linkage structure to enable movement of the seat bottom during a collision of the vehicle. Optionally, in some embodiments, the linkage structure enables rotation of the seat bottom to rotate an occupant seated in the seat, to improve seat belt contact of the occupant, and to prevent submarining of the occupant during the collision. In some embodiments, the linkage structure enables forward movement of the seat bottom in a longitudinal direction to absorb forces experienced by an occupant seated in the seat during the collision. In some embodiments, the linkage structure enables downward movement of a rear portion of the seat bottom in the vertical direction to absorb forces experienced by an occupant seated in the seat during the collision.

### BRIEF DESCRIPTION OF THE DRAWINGS

The present disclosure is illustrated and described with reference to the various drawings, in which like reference numbers are used to denote like assembly components and/or method steps, as appropriate.

FIG. 1 is an overview of a cross-section of an upright and reclined occupant (in the form of a human body model).

FIG. 2 is a side-view diagram of an example seat assembly for reducing spine load of an occupant during a collision of a vehicle.

FIG. 3 is a front-view diagram of an example seat assembly for reducing spine load of an occupant during a collision of a vehicle.

FIGS. 4A and 4B are side-view diagrams of an example compression mechanism used in a linkage structure.

FIG. 5 is a flow chart for manufacturing a seat assembly for a vehicle.

FIG. 6 is a side-view diagram of an example seat assembly for reducing spine load of an occupant during a collision of a vehicle.

FIG. 7 is a front-view diagram of an example seat assembly for reducing spine load of an occupant during a collision of a vehicle.

FIG. 8 is a block diagram of an example computing system of the present disclosure.

### DETAILED DESCRIPTION

As described in more detail herein, embodiments provide a controlled motion of a seat assembly during a collision of a vehicle, where the motion reduces the load on the spine of an occupant during the collision. Embodiments reduce occupant lumbar spine axial loads by means of a seat raiser or pivot mechanism that moves or deforms in a controlled, load limited way, such that the momentum/kinetic energy of the occupant during a collision (e.g., in a frontal crash) is absorbed over a longer distance, leading to lower peak lumbar spine loads. In various embodiments, the motion created by the seat raiser mechanism during a frontal crash is such that the occupant moves forward and downward.

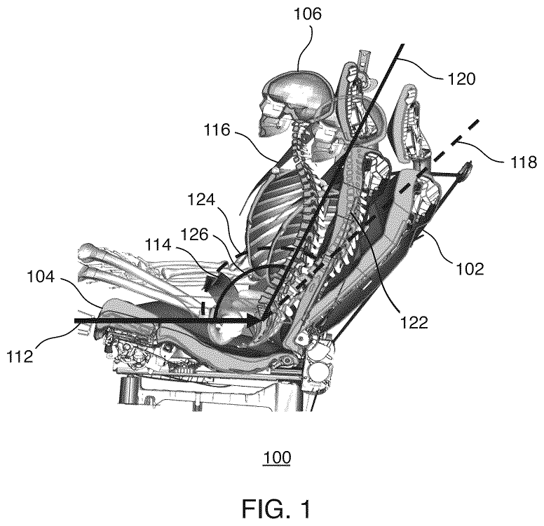

FIG. 1 is an overview of a cross-section of an upright and reclined occupant (in the form of a human body model). As described in more detail herein, a system reduces and minimizes spine load reduction for an occupant during a vehicle collision by changing the position the occupant during the collusion. Shown is seat having a seat back 102 and a seat bottom 104. Also shown is an occupant 106 who is seated in the seat and facing toward the front of the vehicle (not shown).

As shown, the occupant 106 is leaning back against the seat back 102. During a collision event, presuming a front-end collision occurs (in the direction the occupant is facing), a force 112 is transferred from the point of impact toward the occupant 106. The occupant is typically seat belted to the seat. Whether or not the occupant 106 is seat belted to the seat, the momentum of the occupant 106 moves the occupant 106 forward toward the point of impact in the direction of the force 112.

The magnitude of the force 112 is directly proportional to the amount of impact. For example, the greater the speed of the vehicle at impact and the greater the mass of the object (e.g., another car, building, etc.) against which the vehicle collides, the greater the force 112. The greater the force 112, the greater and amount of force the occupant's body is compelled forward toward the point of impact.

During a front-end collision, the occupant 106 will travel longitudinally forward toward the point of impact. The occupant 106 will be substantially stopped by an occupant restraining mechanism such as a seatbelt being worn. The seatbelt may include a waist belt 114 that is strapped across the waist of the occupant and a harness 116 that strapped across the torso of the occupant 106.

In various scenarios, the occupant 106 is reclined in the seat where the seat back 102 is reclined. This would often be the case in an autonomous or driverless vehicle where the occupant 106 need not be in an upright position in order to drive the vehicle. The example of FIG. 1 shows two seat positions, a reclined position 118 and an upright position 120. As shown, the angle of the spine 122 of the occupant 106 follows the angle associated with position of the seat back. In the reclined position 118, the spine 122 of the occupant 106 is similarly reclined. In the upright position 120, the spine 122 of the occupant 106 is similarly upright.

As shown, the reclined position 118 has an associated angle 124 relative to the seat bottom 104. Similarly, the upright position 120 has an associated angle 126 relative to the force 112. The particular reclined position 118 and associated angle 124, and particular upright position 120 and associated angle 126 may vary, depending on the particular scenario. For the illustration purposes, the angle 124 associated with the reclined position is presumed to be greater than the angle 126 associated with the upright position 120.

During a collision, the angle 124 associated with the reclined position, is more dangerous than the angle 126 associated with the upright position. This is because the greater angle applies more force 112 up the spinal column, increasing the risk of injury to the spine, depending on the magnitude of the force 112. The spine 122 being fully reclined (e.g., the angle being 180 degrees) would be the most damaging to the spine 122, because more of the spine 122 will absorb more impact from the force 112. The spine 122 being fully upright (e.g., the angle being 90 degrees) would be the least damaging to the spine 122, because less of the spine 122 will absorb impact from the force 112.

If a seatbelt is not being worn during the collision, the risks described above still apply. For example, if the body of the occupant 106 is not stopped by a seatbelt, the body of the occupant will be stopped by an airbag or by a front instrument panel by a secondary collision. The angle of the spine 122 will absorb impact in a similar manner.

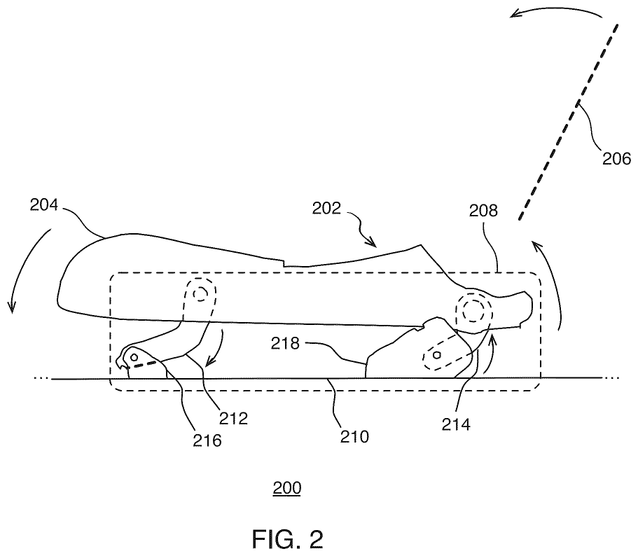

In various embodiments, the system described herein reduces the spine load by pivoting the seat bottom 104, and thereby the seat, during a collision of the vehicle. As described in more detail below, in connection with FIG. 2, the seat bottom 104 pivots such that the front end of the seat bottom 104 travels downward and the rear end of the seat bottom 104 travels upward. Various example embodiments directed to the pivoting of the seat bottom 104 are described in more detail herein.

FIG. 2 is a side-view diagram of an example seat assembly for reducing spine load of an occupant during a collision of a vehicle. Shown is a seat assembly 200 for a vehicle. In various embodiments, the seat assembly 200 includes a seat 202 having a seat bottom 204 and spine axis 206. The seat bottom 204 of FIG. 2 may be used to represent the seat bottom 104 of FIG. 1, and the spine axis 206 of FIG. 2 may be used to represent the recline angle of the spine 122 of FIG. 1.

Also shown is a linkage structure 208. In various embodiments, the linkage structure 208 couples the seat bottom 204 to a floor structure 210 or the floor of the vehicle. In various embodiments, the linkage structure 308 enables movement of the seat bottom 204 during a collision of the vehicle. In various embodiments, the linkage structure 208 includes one or more pivot mechanisms 212 and 214. In various embodiments, the pivot mechanisms 212 and 214 of the linkage structure 208 function to pivot or enable rotation of the seat bottom 204 and thereby the seat 202 during a collision of the vehicle. In various embodiments, the rotation of the seat bottom in turn rotates an occupant seated in the seat in an upright position. The upright position of the occupant improves seat belt contact of the occupant. The upright position of the occupant also prevents submarining of the occupant during the collision. In other words, the linkage structure 208 rotating the occupant in an upright position prevents the occupant from traveling or submarine underneath an instrument panel (not shown) of the vehicle.

As shown, the pivot mechanism 212 is rotatably attached to a front portion of the seat bottom 204 and rotatably attached to the floor structure 210 via a front bracket 216. Also, the pivot mechanism 214 is rotatably attached to a rear portion of the seat bottom 204 and rotatably attached to the floor structure 210 via a rear bracket 218. In other implementations, the seat assembly may not have all of the components shown and/or may have other elements including other types of elements instead of, or in addition to, those shown herein.

In various embodiments, the pivot mechanisms 212 and 214 of the linkage structure 208 provide longitudinal movement and vertical movement of the seat in order to position an occupant seated in the seat to become more upright during the collision. For example, during a front-end collision, the pivot mechanism 212 is configured to rotate clockwise as indicated by the arrow depicted to the right of the pivot mechanism 212. Due to the clockwise rotation of the pivot mechanism 212, the front portion of the seat bottom 204 travels longitudinally toward the rear of the vehicle by a certain amount, and travels vertically downward toward the floor structure 210 by a certain amount.

Also, during a front-end collision, the pivot mechanism 214 rotates counterclockwise as indicated by the arrow depicted to the right of the pivot mechanism 214. Due to the counterclockwise rotation of the pivot mechanism 214, the rear portion of the seat bottom 204 travels longitudinally toward the front of the vehicle by a certain amount, and travels vertically upward away from the floor structure 210 by a certain amount.

As a result, in various embodiments, the pivot mechanisms 112 and 114 of the linkage structure 208 enables the front portion of the seat bottom 204 to lower, and enables the rear portion of the seat 202 bottom to rise during the collision. More specifically, as the pivot mechanism 212 rotates clockwise toward the floor structure 210, the front portion of the seat bottom 204 travels downward toward the floor structure as indicated by the arrow depicted to the left of the seat bottom 204. Also, as the pivot mechanism 214 rotates counter clockwise away from the floor structure 210, the rear portion of the seat bottom 204 travels upward away from the floor structure as indicated by the arrow depicted to the right of the seat bottom 204.

As a result of the front portion of the seat bottom 204 lowering relative to the floor structure 210, and the rear portion of the seat bottom raising relative to the floor structure 210, the angle of the spine axis 206 of the occupant decreases as indicated by the arrow depicted above the spine axis 206. In various embodiments, the movement of the seat bottom 204 forward and downward absorbs energy from a collision thereby further reducing the forces on the spine.

In various embodiments, the pivot mechanisms 212 and 214 of the linkage structure 208 are passive and move (e.g., pivot) the seat 202 during the collision. For example, during a front-end collision, as the occupant is propelled forward toward the front of the vehicle, the legs of the occupant will push the front portion of the seat bottom downward as the rear of the occupant lifts upward. This movement becomes more pronounced when the occupant is wearing a seatbelt. As the occupant is stopped by the seatbelt, the occupant experiences a rotational movement around the waist belt, where the legs of the occupant press downward, and the torso of the occupant travels forward. As a result, the angle of the spine axis 206 decreases relative to the floor structure due to the linkage structure 208 and its pivot mechanisms 212 and 214.

In various embodiments, the pivot mechanisms 212 and 214 of the linkage structure 208 are active, and move (e.g., pivot) the seat 202 in anticipation of the collision. In various embodiments, the vehicle may be equipped with one or more sensors (not shown). The sensors may detect an oncoming obstacle such as another vehicle, road barrier, building, etc. A system of the vehicle may determine an impending collision based on the velocity or speed of the vehicle relative to the oncoming obstacle.

In various embodiments, before and/or during a collision of the vehicle, the system of the vehicle may actively rotate the pivot mechanism 212 clockwise and actively rotate the pivot mechanism 214 counterclockwise. This effectively lowers the front portion of the seat bottom 204 and raises the rear portion of the seat bottom 204. This in turn decreases the angle of the spine axis 206 relative to the floor structure such that the occupant is seated in a more upright position, thereby reducing the load of the spine during the collision.

In various embodiments, electro-mechanical components (not shown) may be integrated into the linkage structure 208, where such electro-mechanical components communicate with a system of the vehicle to actively pivot the pivot mechanisms 212 and 214 as well as other pivot mechanisms (not shown). The electro-mechanical components may communicate with the system via a network (not shown). The network may be any suitable communication network such as a wired network or wireless network, such as a Bluetooth network, a Wi-Fi network, etc.

While example embodiments are described in the context of both pivot mechanisms 212 and 214 pivoting, in various embodiments, it is possible for pivot mechanism 212 to lower the front portion of the seat bottom 204 absent the pivot mechanism 214 pivoting as described above. For example, in some embodiments, presuming the pivot mechanism 212 pivots and the pivot mechanism 214 does not pivot, the rear portion of the seat bottom 204 may still rotate to enable the front portion of the seat bottom 204 to be lowered.

Similarly, in some embodiments, presuming the pivot mechanism 214 does pivot, and the pivot mechanism 212 does not pivot, the front portion of the seat bottom 204 may still rotate to enable the rear portion of the seat bottom 204 to be raised. While to a lesser degree compared to other embodiments described herein, such movements still decrease the angle of the spine axis 206 relative to the floor structure such that the occupant is seated in a more upright position, thereby reducing the load of the spine during the collision.

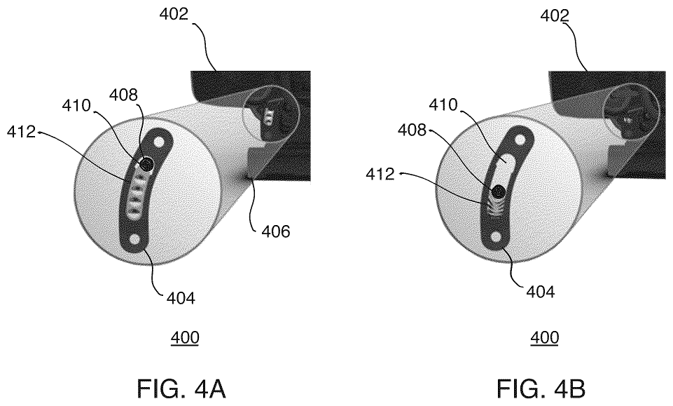

In various embodiments, at least a subset of the linkage structure 208 are adapted to compress or extend in order to pivot the seat during the collision. For example, the pivot mechanism 212 compresses downward in order to pivot the front portion of the seat bottom 204 downward. Also, the pivot mechanism 214 extends upward in order to pivot the rear portion of the seat bottom 204 upward. These pivot mechanisms 212 and 214 of linkage structure 208 compress or extend based on pivoting actions. The techniques used for such compression and extension movements may vary, depending on the particular implementation. Example embodiments directed to compression techniques are described in detail below in connection with FIGS. 4A and 4B.

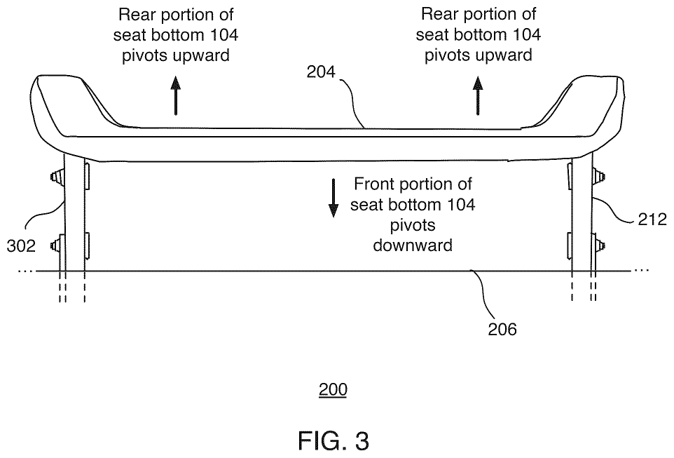

FIG. 3 is a front-view diagram of an example seat assembly for reducing spine load of an occupant during a collision of a vehicle. The front-view diagram of FIG. 3 corresponds to the side-view diagram of FIG. 2. Shown is the seat assembly 200 of FIG. 2, including the pivot mechanism 212 attached to the front of the seat bottom 204. As shown, pivot mechanism 212 is positioned on the right in FIG. 3, and a corresponding pivot mechanism 302 is positioned on the left in FIG. 3. Pivot mechanisms 212 and 302 mirror each other. Similarly, pivot mechanism 214 of FIG. 2 mirrors another pivot mechanism, both of which attach to the rear portion of the seat bottom 204. These rear positioned pivot mechanisms are not shown in FIG. 3, as they are directly behind pivot mechanisms 212 and 302, and are thus hidden from view. In other implementations, the seat assembly may not have all of the components shown and/or may have other elements including other types of elements instead of, or in addition to, those shown herein.

FIGS. 4A and 4B are side-view diagrams of an example compression mechanism used in a linkage structure. Shown is a portion of a front portion of a seat bottom 402 and a compression mechanism 404. The compression mechanism 404 is coupled between the seat bottom 402 and a floor structure (not shown) via a bracket 406 that is attached to the floor structure.

In various embodiments, at least a subset of the linkage structure 208 described herein are adapted to deform during the collision. For example, the compression mechanism 404 may be a subset of pivot mechanisms 212 and 302 of the linkage structure 208 of FIG. 3. FIG. 4A shows the compression mechanism 404 in a non-compressed or non-deformed state. FIG. 4B shows the compression mechanism 404 in a subsequent compressed or deformed state. In other implementations, the linkage structure may not have all of the components shown and/or may have other elements including other types of elements instead of, or in addition to, those shown herein.

Referring to FIG. 4A, a blown up or expanded view of the compression mechanism 404 is shown in a non-compressed or non-deformed state. An extension such as a peg or a bolt 408 is fixedly attached to the seat bottom 402 and passes through a hole or opening 410 in the compression mechanism 404. Just below the bolt 408 is a compressible material 412. The compressible material 412 may be any suitable rigid material that is adapted to deform with force. The particular type of rigid material may vary, depending on the implementation. For example, the material may be a metal, an alloy, or a composite, etc.

Referring to FIG. 4B, a blown up or expanded view of the compression mechanism 404 is shown in a compressed or deformed state. During a collision, as the front portion of the seat bottom 402 travels downward, the bolt 408 also travels downward in the hole and compresses or deforms the compressible material 412. As shown, the hole 410 elongates along the contour of the body of the compression mechanism 404.

In various embodiments, the compression mechanism 404 enables the front portion of the seat bottom 402 to travel downward yet also provides some resistance along the downward path. As such, the compression mechanism 404 functions as a decelerating mechanism such that the front portion of the seat bottom 402 travels downward in a relatively controlled manner. The compression mechanism 404 may also be referred to as a whiplash prevention mechanism.

In various embodiments, the particular techniques used for a compression mechanism may vary, depending on the embodiment. For example, in some embodiments, a wheel or gear may be used in a linkage structure, where the wheel or gear turns in a controlled manner while the seat pivots. In some embodiments, a wheel or gear may break away from a predetermined amount of force during a collision in order to pivot the seat bottom in a controlled manner.

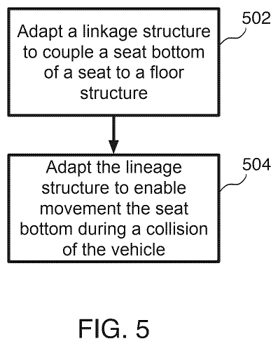

FIG. 5 is a flow chart for manufacturing a seat assembly for a vehicle. Referring to both FIGS. 2, 3, and 5, a method is initiated at block 502, where a linkage structure 208 is adapted to couple a seat bottom 204 of a seat 202 to a floor structure 210. Example embodiments directed to the linkage structure 208 are described above in connection with FIGS. 2 and 3.

At block 504, the linkage structure 208 is adapted to enable movement of the seat bottom during a collision of the vehicle. For example, in some embodiments, one or more pivot mechanisms of the linkage structure 208 such as pivot mechanisms 212 and 214 are adapted to pivot the seat 202 during a collision of the vehicle. Example embodiments directed to the pivot mechanisms 212 and 214 are described above in connection with FIGS. 2 and 3.

As described in more detail above, in various embodiments, the linkage structure enables rotation of the seat bottom to rotate an occupant seated in the seat, to improve seat belt contact of the occupant, and to prevent submarining of the occupant during the collision. Also, the linkage structure enables forward movement of the seat bottom in a longitudinal direction to absorb forces experienced by an occupant seated in the seat during the collision. The linkage structure enables downward movement of a rear portion of the seat bottom in the vertical direction to absorb forces experienced by an occupant seated in the seat during the collision. The linkage structure enables a front portion of the seat bottom to lower and enables a rear portion of the seat bottom to rise during the collision. In some embodiments, the linkage structure is passive and moves the seat during the collision. In some embodiments, the linkage structure is active and moves the seat in anticipation of the collision. In some embodiments, at least a subset of the linkage structure is adapted to compress or extend in order to pivot the seat during the collision. In some embodiments, at least a subset of the linkage structure is adapted to deform during the collision.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Embodiments described herein have numerous benefits. For example, embodiments enable a wider range of safe seating positions, including reclined seating positions, while reducing potential spine load forces. Embodiments may pivot the seat of a vehicle passively or actively during or before a collision of a vehicle in order to protect the spine of an occupant from the force of impact.

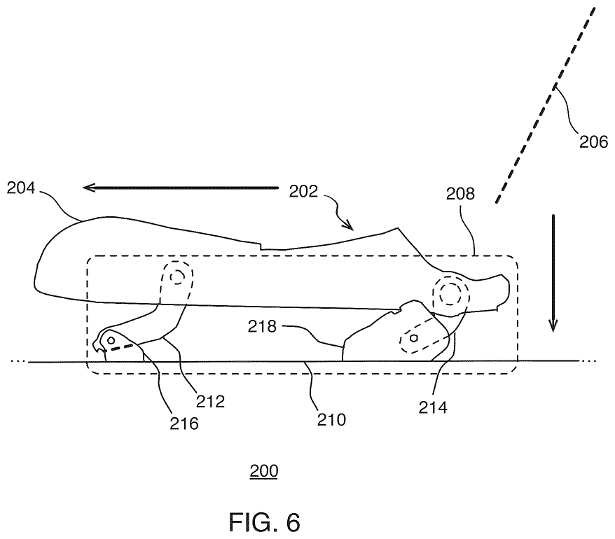

FIG. 6 is a side-view diagram of an example seat assembly for reducing spine load of an occupant during a collision of a vehicle. Shown is a seat assembly 200 for a vehicle. In various embodiments, the seat assembly 200 includes a seat 202 having a seat bottom 204 and spine axis 206. The seat bottom 204 of FIG. 2 may be used to represent the seat bottom 104 of FIG. 1, and the spine axis 206 of FIG. 2 may be used to represent the recline angle of the spine 122 of FIG. 1. Also shown are pivot mechanisms 212 and 214 coupled to the floor 210 via respective front and rear brackets 216 and 218. In other implementations, the seat assembly may not have all of the components shown and/or may have other elements including other types of elements instead of, or in addition to, those shown herein.

Also shown is a linkage structure 208. In various embodiments, the linkage structure 208 couples the seat bottom 204 to a floor structure 210 or the floor of the vehicle. In various embodiments, the linkage structure 308 enables movement of the seat bottom 204 during a collision of the vehicle. In various embodiments, the linkage structure 208 enables forward movement of the seat bottom 204 in a longitudinal direction (indicated by the horizontal arrow depicted above the seat bottom 204 in FIG. 6). Such forward movement enables the seat bottom 204 to absorb forces experienced by an occupant seated in the seat during a collision. For example, during a front collision event, the pivot mechanisms 212 and 214 of the linkage structure 208 enables the seat bottom 204 to move forward in a longitudinal direction to absorb lateral forces resulting from a collision.

In various embodiments, the linkage structure 208 also enables downward movement of a rear portion of the seat bottom in the vertical direction (indicated by the vertical arrow depicted to the right of the seat bottom 204 in FIG. 6). Such downward movement enables the seat bottom 204 to absorb forces experienced by an occupant seated in the seat during the collision. For example, during a front collision event, the pivot mechanisms 212 and 214 of the linkage structure 208 enables the seat bottom 204 to move downward in a vertical direction to absorb lateral forces resulting from a collision.

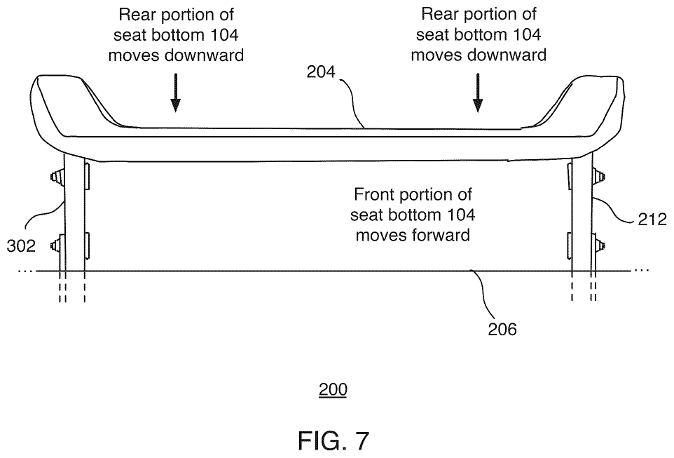

FIG. 7 is a front-view diagram of an example seat assembly for reducing spine load of an occupant during a collision of a vehicle. The front-view diagram of FIG. 7 corresponds to the side-view diagram of FIG. 6. Shown is the seat assembly 200 of FIG. 2, including the pivot mechanism 212 attached to the front of the seat bottom 204. As shown, pivot mechanism 212 is positioned on the right in FIG. 3, and a corresponding pivot mechanism 302 is positioned on the left in FIG. 3. Pivot mechanisms 212 and 302 mirror each other. Similarly, pivot mechanism 214 of FIG. 6 mirrors another pivot mechanism, both of which attach to the rear portion of the seat bottom 204. These rear positioned pivot mechanisms are not shown in FIG. 7, as they are directly behind pivot mechanisms 212 and 302, and are thus hidden from view. In other implementations, the seat assembly may not have all of the components shown and/or may have other elements including other types of elements instead of, or in addition to, those shown herein.

As described above in connection with FIG. 6, in various embodiments, the linkage structure 208 enables forward movement of the seat bottom 204 in a longitudinal direction (indicated by the horizontal arrow depicted above the seat bottom 204 in FIG. 6) to absorb forces experienced by an occupant seated in the seat during a collision. Also, in various embodiments, the linkage structure 208 also enables downward movement of a rear portion of the seat bottom in the vertical direction (indicated by the vertical arrows depicted to above the seat bottom 204 in FIG. 7). Such downward movement enables the seat bottom 204 to absorb forces experienced by an occupant seated in the seat during the collision.

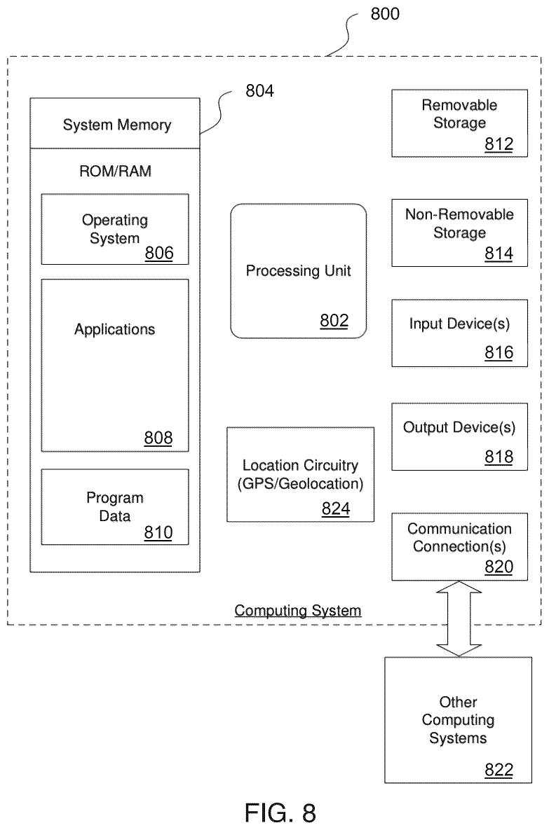

FIG. 8 is a block diagram of an example computing system 800 of the present disclosure. The computing system 800 may be used to implement any system referred to herein that controls any electro-mechanical components describe herein, as well as to perform implementations described herein.

The computing system 800 typically includes at least one processing unit 802 and a system memory 804. Depending on the particular configuration and type of computing device, the system memory 804 may be volatile such as random-access memory (RAM), non-volatile such as read-only memory (ROM), flash memory, and the like, or some combination of volatile memory and non-volatile memory. The system memory 804 typically maintains an operating system 806, one or more applications 808, and program data 810. The operating system 806 may include any number of operating systems executable on desktops or portable devices including, but not limited to, Linux, Microsoft Windows®, Apple OS®, or Android®.

The computing system 800 may also have additional features or functionality. For example, the computing system 800 may also include additional data storage devices (removable and/or non-removable) such as, for example, magnetic disks, optical disks, tape, or flash memory. Such additional storage may include removable storage 812 and non-removable storage 814. Computer storage media may include volatile and non-volatile, removable and non-removable media implemented in any method or technology for storage of information, such as computer-readable instructions, data structures, program modules or other data. The system memory 804, the removable storage 812, and the non-removable storage 814 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 800. Any such computer storage media may be part of the computing system 800.

The computing system 800 may also have input device(s) 816 such as a keyboard, mouse, pen, voice input device, touchscreen input device, etc. Output device(s) 818 such as a display, speakers, printer, short-range transceivers such as a Bluetooth transceiver, etc., may also be included. The computing system 800 also may include one or more communication connections 820 that allow the computing system 800 to communicate with other computing systems 822, such as over a wired or wireless network or via Bluetooth (a Bluetooth transceiver may be regarded as an input/output device and a communications connection). The one or more communication connections 820 are an example of communication media. Available forms of communication media typically carry computer-readable instructions, data structures, program modules or other data in a modulated data signal such as a carrier wave or other transport mechanism and include any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media.

The computing system 800 may also include location circuitry 824. In various embodiments, the location circuitry 824 may include circuitry including global positioning system (GPS) circuitry and/or geolocation circuitry. The location circuitry 824 may automatically discern its location based on relative positions to multiple GPS satellites and/or triangulation using cellular carrier network(s) and/or IEEE Standard 802.11 wireless (Wi-Fi) networks (collectively referred to as “geolocation services”) to determine location based on multiple cellular communications facilities and/or multiple Wi-Fi networks. The location circuitry 824, including GPS circuitry and/or geolocation circuitry, is frequently incorporated in smartphones and many other tablets or other portable devices. In various embodiments, computing system 800 may not have all of the components shown and/or may have other elements including other types of components instead of, or in addition to, those shown herein.

Although the present disclosure is illustrated and described herein with reference to illustrative embodiments and specific examples provided, it will be readily apparent to those of ordinary skill in the art that other embodiments and examples may perform similar functions and/or achieve like results. All such equivalent embodiment and examples are within the spirit and scope of the present disclosure and are intended to be covered by the following non-limiting claims for all purposes.

What is claimed is:

1. A seat assembly for a vehicle, the seat assembly comprising:
a seat having a seat bottom; and
a linkage structure for coupling the seat bottom to a floor structure, wherein the linkage structure enables movement of the seat bottom during a collision of the vehicle.

2. The seat assembly of claim 1, wherein the linkage structure enables rotation of the seat bottom to rotate an occupant seated in the seat, to improve seat belt contact of the occupant, and to prevent submarining of the occupant during the collision.

3. The seat assembly of claim 1, wherein the linkage structure enables forward movement of the seat bottom in a longitudinal direction to absorb forces experienced by an occupant seated in the seat during the collision.

4. The seat assembly of claim 1, wherein the linkage structure enables downward movement of a rear portion of the seat bottom in the vertical direction to absorb forces experienced by an occupant seated in the seat during the collision.

5. The seat assembly of claim 1, wherein the linkage structure enables a front portion of the seat bottom to lower and enables a rear portion of the seat bottom to rise during the collision.

6. The seat assembly of claim 1, wherein the linkage structure is passive and moves the seat during the collision.

7. The seat assembly of claim 1, wherein the linkage structure is active and moves the seat in anticipation of the collision.

8. The seat assembly of claim 1, wherein at least a subset of the linkage structure is adapted to compress or extend in order to pivot the seat during the collision.

9. The seat assembly of claim 1, wherein at least a subset of the linkage structure is adapted to deform during the collision.

10. A vehicle comprising:
a seat having a seat bottom; and
a linkage structure for coupling the seat bottom to a floor structure, wherein the linkage structure enables movement of the seat bottom during a collision of the vehicle.

11. The vehicle of claim 8, wherein the linkage structure enables rotation of the seat bottom to rotate an occupant seated in the seat, to improve seat belt contact of the occupant, and to prevent submarining of the occupant during the collision.

12. The vehicle of claim 8, wherein the linkage structure enables forward movement of the seat bottom in a longitudinal direction to absorb forces experienced by an occupant seated in the seat during the collision.

13. The vehicle of claim 8, wherein the linkage structure enables downward movement of a rear portion of the seat bottom in the vertical direction to absorb forces experienced by an occupant seated in the seat during the collision.

14. The vehicle of claim 8, wherein the linkage structure enables a front portion of the seat bottom to lower and enables a rear portion of the seat bottom to rise during the collision.

15. The vehicle of claim 8, wherein the linkage structure is passive and moves the seat during the collision.

16. The vehicle of claim 8, wherein the linkage structure is active and moves the seat in anticipation of the collision.

17. A method for manufacturing a seat assembly for a vehicle, the method comprising:
adapting a linkage structure to couple a seat bottom of a seat to a floor structure; and
adapting the linkage structure to enable movement of the seat bottom during a collision of the vehicle.

18. The method of claim 15, wherein the linkage structure enables rotation of the seat bottom to rotate an occupant seated in the seat, to improve seat belt contact of the occupant, and to prevent submarining of the occupant during the collision.

19. The method of claim 15, wherein the linkage structure enables forward movement of the seat bottom in a longitudinal direction to absorb forces experienced by an occupant seated in the seat during the collision.

20. The method of claim 15, wherein the linkage structure enables downward movement of a rear portion of the seat bottom in the vertical direction to absorb forces experienced by an occupant seated in the seat during the collision.
